(19) United States
(12) Patent Application Publication
(10) Pub. No.: US 2026/0112633 A1
(43) Pub. Date: Apr. 23, 2026

(54) POROUS ANODE FOR A LITHIUM ION BATTERY CELL, METHOD OF FABRICATING A POROUS ANODE, AND METHOD OF ASSEMBLING A LITHIUM ION BATTERY CELL

(71) Applicants: The Board of Trustees of the University of Illinois, Urbana, IL (US); Samsung SDI Co., Ltd., Yongin-si (KR)

(72) Inventors: Paul V. Braun, Champaign, IL (US); Sung Bum Kang, Champaign, IL (US); Changyong Park, Champaign, IL (US); Yuxin Zhang, Cambridge, MA (US); Ho Kim, Seoul (KR); Hyejeong Jeong, Seoul (KR); Yuuya Arikawa, Hwaseong (KR); Jungjoon Kim, Cambridge, MA (US); Yongseok Kim, Newton, MA (US)

(21) Appl. No.: 18/924,673

(22) Filed: Oct. 23, 2024

(51) Int. Cl. H01M 4/62; H01M 4/02; H01M 4/04; H01M 4/133; H01M 4/1393; H01M 4/587; H01M 10/0525

(52) U.S. Cl. CPC H01M 4/62; H01M 4/0404; H01M 4/0409; H01M 4/0435; H01M 4/0471; H01M 4/133; H01M 4/1393; H01M 4/587; H01M 10/0525; H01M 2004/021; H01M 2004/027

(57) ABSTRACT

A method of fabricating a porous anode for a lithium-ion battery cell comprises forming an anode coating on a conductive substrate, where the anode coating comprises an anode material, a solvent, a dissolved lithium salt and a binder. The dissolved lithium salt is crystallized to form lithium salt crystals throughout the anode coating. The solvent is removed from the anode coating, leaving the anode material with the lithium salt crystals distributed therein adhered to the conductive substrate. After removing the solvent, the anode material containing the lithium salt crystals is compacted on the conductive substrate, thereby forming an anode. The anode is immersed in an electrolyte, such that the electrolyte penetrates the anode material. The lithium salt crystals dissolve into the electrolyte, leaving pores in the anode material and increasing an ion concentration of the electrolyte. The immersion may take place during assembly of a battery cell.

### TECHNICAL FIELD

This disclosure is related generally to lithium-ion battery technology and more particularly to fabrication and use of a porous anode.

### BACKGROUND

Lithium-ion batteries are rechargeable batteries that store and release energy by the motion of lithium ions through an electrolyte between a positively charged cathode and a negatively charged anode. During the charging process, there is a progressive migration of lithium ions from the cathode to the anode via the electrolyte. During discharging, lithium ions are released from the anode and travel through the electrolyte for insertion into the cathode. Both the anode and cathode are made of materials that can absorb or intercalate lithium ions.

The development of fast-charging lithium-ion batteries is of paramount importance in the rapidly evolving fields of electric vehicles and portable electronic devices. A critical challenge in this domain is the enhancement of the performance of the anode.

Graphite, which is a favored anode material in lithium-ion batteries, may encounter problems during rapid charging, including pronounced polarization, reduced intercalation capacity, harmful side reactions, and dendrite growth. These issues can significantly impede the rapid charging of Li-ion batteries, which is a limitation in automotive and other applications where fast charging demands are increasing. It would be beneficial to fabricate an anode to address these challenges.

### SUMMARY

A method of fabricating a porous anode for a lithium-ion battery cell, a method of assembling a lithium ion battery cell, a slurry for fabricating a porous anode, and a porous anode for a lithium ion battery cell are described in this disclosure.

The method of fabricating the porous anode comprises forming an anode coating on a conductive substrate, where the anode coating comprises an anode material, a solvent, a dissolved lithium salt and a binder. The dissolved lithium salt is crystallized to form lithium salt crystals throughout the anode coating. The solvent is removed from the anode coating, leaving the anode material with the lithium salt crystals distributed therein adhered to the conductive substrate. After removing the solvent, the anode material containing the lithium salt crystals is compacted on the conductive substrate, thereby forming an anode. The anode is immersed in an electrolyte, such that the electrolyte penetrates the anode material. The lithium salt crystals dissolve into the electrolyte, leaving pores in the anode material and increasing an ion concentration of the electrolyte.

The method of assembling a battery cell comprises immersing a cathode, a separator, and an anode in an electrolyte. The anode comprises an anode material including lithium salt crystals dispersed therein on a conductive substrate. Upon immersing the anode in the electrolyte, the electrolyte penetrates the anode material and the lithium salt crystals dissolve into the electrolyte, leaving pores in the anode material and increasing an ion concentration of the electrolyte.

The slurry for fabricating a porous anode comprises an anode material, a binder, a lithium salt, and a solvent for the lithium salt.

The porous anode comprises a conductive substrate and an anode material on the conductive substrate, where the anode material comprises a population of pores formed by removal of lithium salt crystals.

### BRIEF DESCRIPTION OF THE DRAWINGS

FIG. 1 shows a flow chart of a method of forming a porous anode.

FIG. 2 shows an exemplary slurry coating process to form an anode coating on a conductive substrate.

FIG. 3 shows an exemplary process for preparing a slurry including an anode material (graphite), a solvent (water), a dissolved lithium salt (LiClO₄), and a binder (CMC and SBR).

FIGS. 4A-4C schematically show the change in microstructure of an anode coating before (FIG. 4A) and after (FIG. 4B) crystallization of the lithium salt, and after (FIG. 4C) removal of the (frozen) solvent by sublimation.

FIG. 5 is a scanning electron microscope (SEM) image of the microstructure of the anode material after removing the water (ice) from the LiClO₄·3H₂O crystals via freeze drying.

FIG. 6 is an x-ray diffraction (XRD) spectrum obtained from a bare graphite anode material (bottom) in comparison with an XRD spectrum obtained from a graphite anode material containing dispersed LiClO₄ crystals (top).

FIGS. 7A and 7B are SEM images of an ion-milled bare graphite anode material, and an ion-milled graphite anode material after removal of the LiClO₄ crystals, respectively.

FIG. 8 shows discharge capacity versus cycle number for bare graphite anodes and graphite anodes formed with 5 wt. % LiClO₄.

FIG. 9 shows discharge capacity values at 0.1 C, 0.33 C, 1C, 2C, 3C, and 4C for the bare graphite and graphite anodes formed with 5 wt. % LiClO₄.

FIG. 10 shows ionic conductivity of a bare graphite anode and a graphite anode formed with 5 wt. % LiClO₄.

FIG. 11 shows an electrochemical impedance spectroscopy (EIS) plot showing data for a bare (pristine) graphite anode and a graphite anode formed with 5 wt. % LiClO₄.

### DETAILED DESCRIPTION

A new anode fabrication method utilizes a lithium-based salt to (a) create pores in the anode upon immersion in an electrolyte and (b) ultimately serve as an active element of the battery chemistry. The anode design and battery cell assembly method described in this disclosure may lead to lithium-ion batteries with improved performance, especially at high C rates. The porous anode structure created by dissolution of lithium salt crystals during battery cell assembly can facilitate faster ion transport and improve the battery's rate capability when operating under high discharge rates. In addition, incorporation of the dissolved lithium salt into the electrolyte can enhance the ionic conductivity and overall efficiency of the battery.

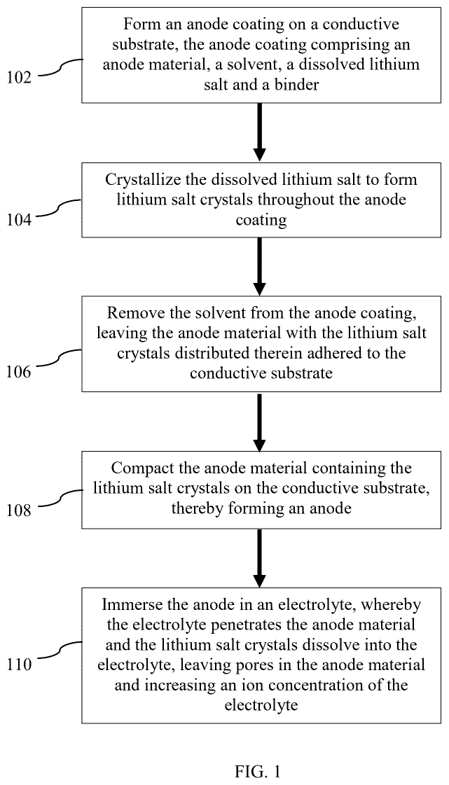

The method of preparing a porous anode is described broadly first in reference to FIG. 1, and then in detail below according to various implementations. Referring to the flow chart of FIG. 1, the method includes forming 102 an anode coating on a conductive substrate, where the anode coating comprises an anode material, a solvent, a dissolved lithium salt and a binder. The anode material is capable of intercalating lithium ions and typically takes the form of particles, flakes, and/or fibers. The lithium salt is selected to be soluble in the solvent, which typically comprises water or an aqueous solution, but in some examples may comprise an organic solvent. The binder promotes adhesion among the particles/flakes/fibers of the anode material and also helps to adhere the anode material to the conductive substrate.

Referring again to FIG. 1, the dissolved lithium salt is crystallized 104 to form lithium salt crystals throughout the anode coating. The solvent is removed 106 from the anode coating (during and/or after crystallization, as discussed below), leaving the anode material, with the lithium salt crystals distributed therein, adhered to the conductive substrate. The anode material containing the lithium salt crystals is then compacted 108 on the conductive substrate to form an anode. Finally, the anode is immersed 110 in an electrolyte, and the electrolyte penetrates the anode material. The lithium salt crystals dissolve into the electrolyte, leaving pores in the anode material and increasing an ion concentration of the electrolyte. This last step may occur during assembly of a lithium-ion battery cell.

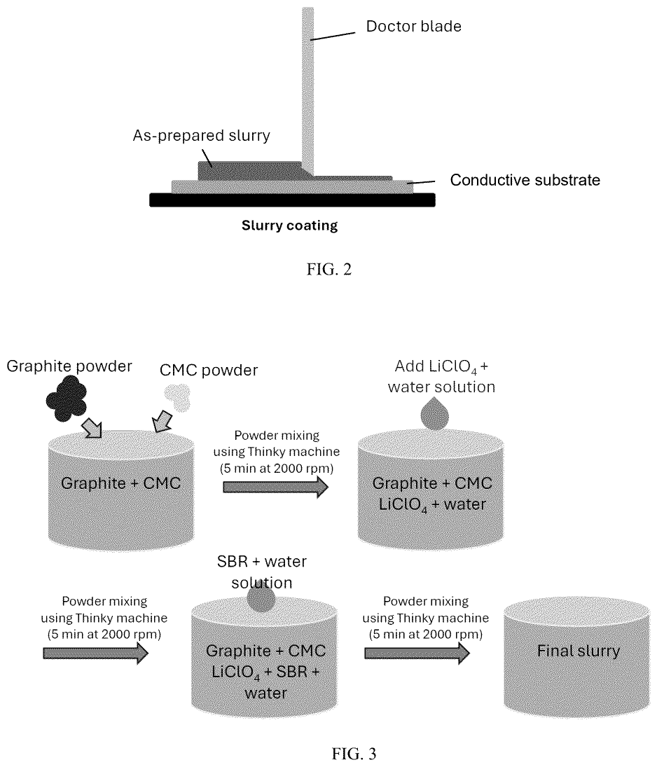

The anode coating may be formed using a slurry coating process. That is, any deposition, casting or printing method capable of coating a slurry comprising the anode material, the solvent, the dissolved lithium salt, and the binder onto the conductive substrate may be employed. Suitable slurry coating processes may include, for example, doctor blade coating (illustrated in FIG. 2), spin coating, dip coating, spray coating and/or bar coating.

The anode coating may be formed under ambient conditions, such as in air at atmospheric pressure and room temperature (e.g., 18-22° C.).

The method may thus further include preparing the slurry. Slurry constituents may be added incrementally or simultaneously, and mixed thoroughly. For example, an anode material may be mixed with a binder to form a first mixture, a dissolved lithium salt and solvent may be added to the first mixture and thoroughly mixed to form a second mixture, and then an additional binder and solvent may be added and thoroughly mixed to form the final slurry. This general approach is illustrated in FIG. 3 for a particular slurry formulation which is described in the Examples below. Mixing may entail stirring, agitation, ultrasonication, and/or another technique. An apparatus such as a planetary centrifugal mixer (e.g., a Thinky mixer) may be employed for mixing.

Typically, only a small amount of the dissolved lithium salt (e.g., 1-10 wt. %) relative to the anode material is incorporated into the slurry. Similarly, the binder(s) may be present in a small amount from about 1-10 wt. % relative to the anode material. Optionally, a nucleation agent that facilitates crystallization of the lithium salt may be included in the slurry. In some examples, a conductive additive or other additive(s) may be incorporated into the slurry. It is understood that the composition of the anode coating formed on the conductive substrate is the same as or substantially the same as that of the slurry.

Typically, the anode material comprises graphite, although other anode materials, such as lithium titanate (Li₄Ti₅O₁₂), silicon (Si), silicon (Si)-graphite composite, tin oxide (SnO₂), silicon oxide (SiO₂), and/or silicon suboxide (SiOₓ, where 0<x<2) may be employed.

The dissolved lithium salt may comprise a lithium cation and a salt anion, such as lithium perchlorate (LiClO₄), lithium hexafluoroarsenate (LiAsF₆), lithium hexafluorophosphate (LiPF₆), lithium tetrafluoroborate (LiBF₄), lithium triflouromethanesulfonate or LiOTf (LiCF₃SO₃), lithium bis(trifluoromethanesulfonyl)imide (LiTFSI), lithium bis(pentafluoroethanesulfonyl)imide (LiBETI), lithium bis(oxalato)borate (LiBOB), lithium dicyanotriazolate (LiDCTA), lithium 4,5-dicyano-2-trifluoromethylimidazole (LiTDI), and lithium 4,5-dicyano-2-(pentafluoroethyl) imidazolide (LiPDI).

As indicated above, the solvent typically comprises water or an aqueous solution. Alternatively, suitable organic solvents may include ethylene carbonate (EC), dimethyl carbonate (DMC), dimethoxyethane (DME), dioxolane (DOL), and/or tetraethylene glycol dimethyl ether (TEGDME).

Suitable binders may include carboxylmethyl cellulose and/or styrene-butadiene rubber, for example.

The optional nucleation agent may comprise poly-l-lysine (PLL), polyethyleneimine (PEI), poly-L-glutamic acid, and/or polystyrene sulfonate (PSS). The nucleation agent may help to promote crystallization of the lithium salt. Also or alternatively, the nucleation agent may facilitate the formation of more uniformly distributed lithium salt crystals throughout the anode material. Accordingly, the nucleation agent may help to minimize the formation of agglomerates (aggregates or clusters) of the lithium salt crystals.

Optional conductive additives may include carbon particles, carbon black, carbon nanotubes, and/or graphene.

The conductive substrate that supports the anode coating is advantageously an electrically conductive substrate suitable for use as a current collector in a lithium ion battery. For example, the conductive substrate may comprise copper or another electrically conductive material such as aluminum, nickel or titanium. Typically the conductive substrate takes the form of a foil, mesh or plate.

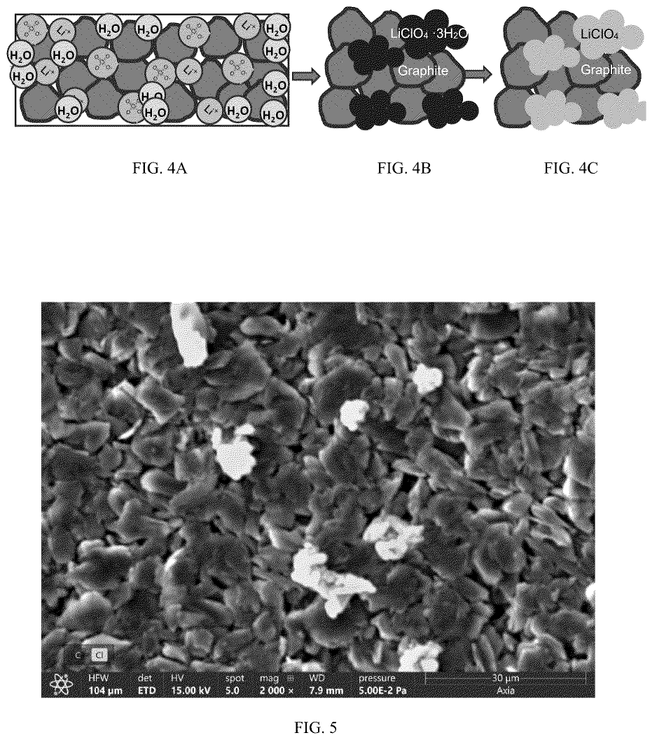

After formation of the anode coating, the dissolved lithium salt is crystallized as explained below, such that lithium salt crystals form throughout the anode coating. In some examples, such as when the solvent is water and the lithium salt is appropriately selected, the lithium salt may become hydrated, that is, chemically bonded with water molecules (Li salt·xH₂O), upon crystallization. FIGS. 4A and 4B schematically illustrate the transformation of the microstructure of the anode coating before and after crystallization, respectively, for an exemplary anode coating formulation which is described in the Examples. FIG. 4C illustrates the microstructure after removal of the solvent (ice or hydrate) by sublimation, as explained below.

It is preferred that the lithium salt crystals are uniformly distributed throughout the anode coating and are not localized to one region (e.g., the surface) of the coating. Typically, the lithium salt crystals or crystal aggregates have a linear size (length or width) less than about 20 microns, less than about 10 microns, or less than about 5 microns, and/or typically greater than about 1 micron. Due to the crystallization process and/or the selection of the lithium salt, the lithium salt crystals may in some examples have a rod-like or needle-like shape. More generally, some or all of the lithium salt crystals may be described as having an elongated shape with a length-to-width aspect ratio of greater than 1, or preferably greater than 1.5, or greater than 2. In addition, the long axis of some or all of the lithium salt crystals is preferably oriented substantially normal to the substrate or the thickness direction of the anode coating. This preferred orientation may be achieved during crystallization. The distribution, morphology and orientation of the lithium salt crystals within the anode material may ultimately influence or determine the distribution, morphology and orientation of pores that form in the anode upon immersion in the electrolyte, as discussed below. Control over the porosity is important as the lithium salt-generated pores provide additional pathways for ion diffusion through the anode material.

As indicated above, removal of the solvent may occur during and/or after crystallization, leaving the anode material and the lithium salt crystals adhered to the conductive substrate, aided by the binder. Two different crystallization approaches and removal of the solvent are discussed below.

In one approach, crystallization of the lithium salt may be induced by cooling the anode coating to a temperature at or below a freezing point of the solvent. Typically, the temperature is well below 0° C., and the cooling may occur rapidly. For example, the anode coating may be immersed in liquid nitrogen (−196° C.), as schematically illustrated in FIG. 5A. Accordingly, the solvent solidifies as the lithium salt crystallizes. When the solvent is water, ice crystals may form. The freezing may occur directionally, e.g., in a direction normal to the substrate, which may affect the orientation, alignment and/or morphology of the lithium salt crystals.

The solvent may then be removed by sublimation in a process referred to as freeze drying, which may take place in a vacuum environment (e.g., provided by a freeze dryer) at a temperature that may be between −50° C. and −80° C., for example. During freeze drying, heat may be carefully applied to the anode coating to promote sublimation of the solvent. Freeze drying may be followed by vacuum drying of the anode coating at a temperature above the freezing point of the solvent, with the objective of removing any remaining (liquid) solvent from the anode coating by evaporation.

In another approach, crystallization may be induced controlled drying of the anode coating without utilizing the cooling (freezing) step described above. Accordingly, in this alternative approach, the solvent does not undergo freezing. Instead, crystallization (or precipitation) of dissolved lithium salt occurs simultaneously with controlled evaporation of the (liquid) solvent from the anode coating. Controlled drying may be carried out under vacuum conditions (e.g., in an oven) at a temperature of about 70° C. or higher, or about 80° C. or higher.

After removal of the solvent, the anode material containing the lithium salt crystals may undergo compaction or pressing to form an anode that is ready for assembly into a battery cell. Compaction typically entails calendaring, which refers to passage of the material to be compacted (in this case, the Li salt-containing anode material on the conductive substrate) between rollers having a predetermined spacing. After compaction, the anode material may have an increased relative density of about 20-70%. The increase in relative density after calendaring can vary depending on the material, the level of compaction applied, and the initial porosity of the anode coating. The anode formed by compaction may refer to the anode material, which includes the lithium salt crystals distributed therein, and to the conductive substrate—or current collector—to which the anode material is adhered.

In a final step of forming the porous anode, the anode is immersed in an electrolyte (e.g., within a battery cell). As a result of the immersion, the electrolyte penetrates the anode material and the lithium salt crystals gradually dissolve into the electrolyte. After a sufficient immersion time (e.g., typically from 1-2 days) the anode material is substantially or completely devoid of the lithium salt crystals. The dissolution of the lithium salt crystals leaves pores in the anode while also advantageously increasing the ion concentration of the electrolyte. A cathode and a separator may also be immersed in the electrolyte as part of assembling the battery cell prior to operation.

Accordingly, the preceding method enables the formation of a porous anode for a lithium-ion battery. The porous anode comprises a conductive substrate and an anode material on the conductive substrate, where the anode material comprises a population of pores formed by removal of lithium salt crystals. The pores may have a linear size (length or width) that depends on the size of the lithium salt crystals or crystal aggregates that have been removed. Typically the linear size of the pores is typically less than about 20 microns, less than about 10 microns, or less than about 5 microns, and/or typically greater than about 1 micron. The anode material may comprise graphite, lithium titanate (Li₄Ti₅O₁₂), silicon (Si), silicon (Si)-graphite composite, tin oxide (SnO₂), silicon oxide (SiO₂), and/or silicon suboxide (SiOₓ, where 0<x<2) in the form of particles, flakes or fibers. Small amounts of a binder (e.g., 1-10 wt. % relative to the anode material) incorporated during fabrication of the anode may help ensure that the anode material adheres to the conductive substrate. In some examples, such as when the anode material comprises flakes, the flakes may be aligned roughly parallel to the conductive substrate following compaction or calendaring, forming graphite layers. Accordingly, the pores may serve as pathways through the anode material (e.g., as bridges between graphite layers) facilitating ion diffusion when the battery is being charged or discharged. In some examples, the pores may have an elongated shape with a length-to-width aspect ratio of greater than 1, or preferably greater than 1.5, or greater than 2. For example, the pores may have a rod-like or needle-like shape. At least some of the pores may be oriented substantially perpendicular to (e.g., have a long axis oriented substantially perpendicular to) the conductive substrate. When used in a lithium ion battery cell, the porous anode formed as described in this disclosure enables higher specific capacities and increased ionic conductivity to be achieved, as illustrated in the Examples below.

### EXAMPLES

### Slurry Preparation

In this example, which is illustrated in FIG. 3, graphite powder (particles) and carboxymethyl cellulose (CMC) powder (particles) are mixed in a weight ratio of 95:2.5 in a mixing container and blended for 5 min at 2000 rpm using a Thinky mixer. Subsequently, an aqueous solution containing 5 wt. % LiClO₄ relative to graphite is added to the mixing container and mixed again for 5 min at 2000 rpm with the Thinky mixer. Following this, a solution containing 2.5 wt. % styrene-butadiene rubber (SBR) is added, and the mixture is blended once more for 5 min at 2000 rpm using the Thinky mixer.

### Slurry Coating

The as-prepared slurry, which includes water as the solvent, is coated to the desired thickness on a conductive substrate, in this example a copper current collector (10 μm), using a doctor blade, illustrated in FIG. 2. An anode coating is thus formed by slurry coating or slurry casting onto the conductive substrate.

### Freeze-Drying Process

The anode coating (supported on the conductive substrate) undergoes rapid cooling in liquid nitrogen to induce crystallization of the lithium salt and freezing of the solvent (in this example, water). The coated substrate then undergoes freeze-drying in a freeze dryer. During freeze drying, frozen solvent (ice or hydrate) is removed from the anode coating by sublimation, leaving the graphite particles and crystallized lithium salt on the conductive substrate. The binder (CMC and SBR) added to the slurry ensures that the graphite particles and lithium salt crystals distributed therein adhere to each other and/or to the conductive substrate.

### Calendaring Process

After freeze-drying, the coated substrate, which includes the graphite particles and lithium salt crystals bound to the conductive substrate, is pressed to a desired thickness using a calendaring machine, resulting in an anode ready for assembly into a battery cell.

### Cell Assembly

2032-type coin cells are assembled in an Ar-filled glove box. The anode prepared as described above is employed. A polypropylene membrane (Celgard membrane) is used as a separator. Lithium metal foil is used as a reference and counter electrode. A commercial electrolyte (RD810) is used as a electrolyte. RD810 has the composition: 1.15M lithium hexafluorophosphate (LiPF₆) in ethylene carbonate (EC), ethyl methyl carbonate (EMC), and diethyl carbonate (DEC) in (2:6:2 v/v/v)+10 wt. % fluoroethylene carbonate (FEC)+1 wt. % propane sultone (PS).

### Anode Material Characterization

FIG. 5 is a scanning electron microscope (SEM) image of the microstructure of the anode material after removing the water (ice) from the LiClO₄·3H₂O crystals via sublimation (freeze drying). The SEM image is complemented by energy dispersive x-ray spectroscopy (EDS), where chloride appears as bright white clusters.

FIG. 6 shows an x-ray diffraction (XRD) spectrum obtained from a bare graphite anode material (bottom) in comparison with an XRD spectrum obtained from a graphite anode material containing dispersed LiClO₄ crystals (top), where peaks associated with the LiClO₄ are indicated with vertical dotted lines.

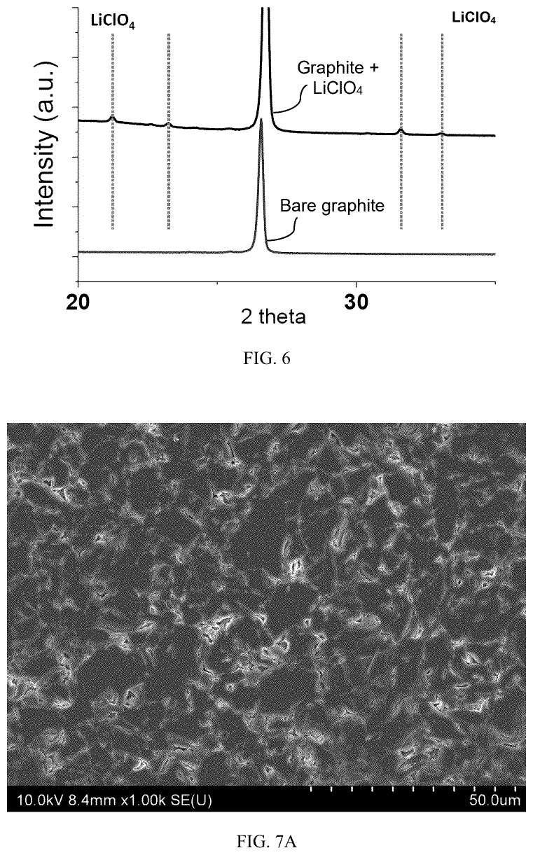

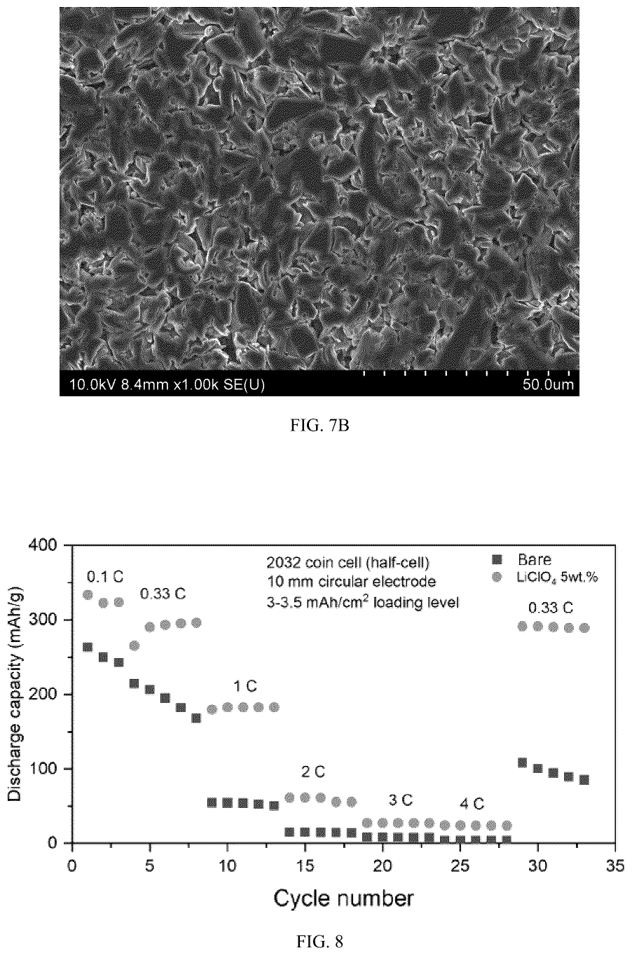

FIG. 7A is a SEM image of an ion-milled bare graphite anode material.

FIG. 7B is a SEM image of an ion-milled graphite anode material after removal of LiClO₄ crystals by washing with the organic solvent DMC, leaving a graphite anode material with enhanced porosity.

### Electrochemical Testing

Rate capability results of half-cells including bare graphite anodes and graphite anodes formed with 5 wt. % LiClO₄ were conducted at a commercial mass loading level of 3-3.5 mAh/cm² at 25° C. The graphite anodes formed with 5 wt. % LiClO₄ demonstrated higher specific capacity values than the bare graphite anodes at all C-rates, where 1C=372 mA/g, as shown in FIG. 8. This improvement is attributed to the porous structure created by the pore-forming LiClO₄ crystals. The pores formed upon dissolution of the LiClO₄ in the electrolyte act as an ionic pathway and reduce ion diffusion resistance.

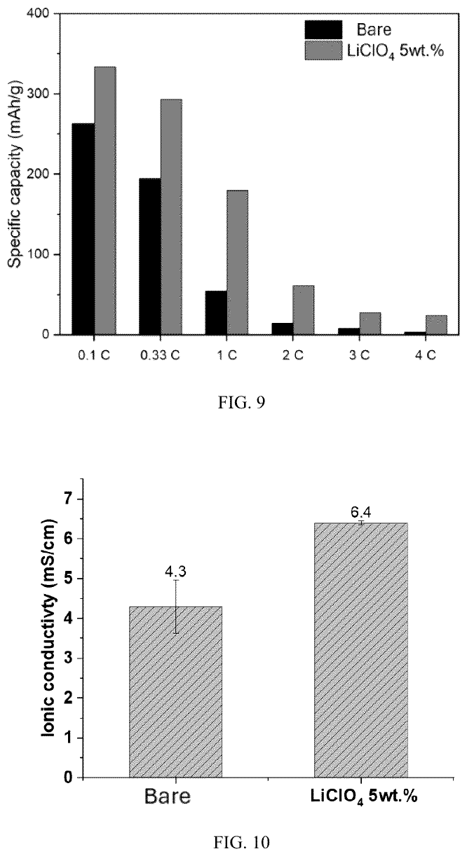

FIG. 9 shows discharge capacity values at 0.1 C, 0.33 C, 1C, 2C, 3C, and 4C for cells including the bare graphite and graphite anodes formed with 5 wt. % LiClO₄. At slow charging rates of 0.1 C and 0.33 C, the cells containing graphite anodes formed with 5 wt. % LiClO₄ exhibited higher capacities compared to those containing bare graphite anodes. Notably, at rates above 1C, the capacity difference exceeded threefold.

FIG. 10 shows ionic conductivity of cells containing the bare graphite anode and a graphite anode formed with 5 wt. % LiClO₄. The latter electrode, which includes pores formed upon dissolution of the LiClO₄ crystals, results in an ionic conductivity approximately 1.5 times higher than that of the bare graphite electrode. This enhancement is believed to be due to the improved ionic accessibility to the graphite particles that is facilitated by the porous structure.

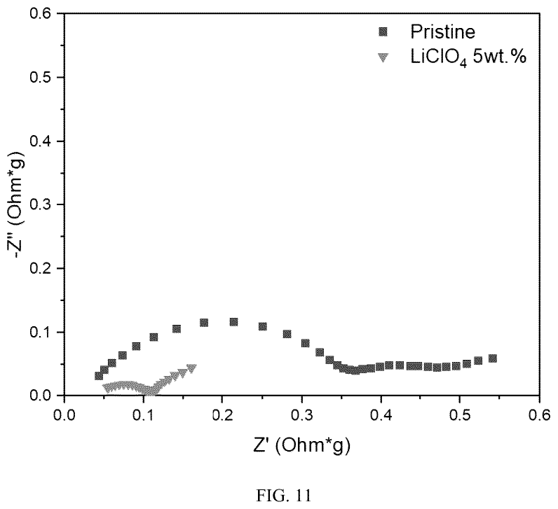

FIG. 11 shows an electrochemical impedance spectroscopy (EIS) plot. In the data, presence of a smaller semicircle for a graphite anode formed with 5 wt. % LiClO₄ than for a bare or pristine graphite electrode signifies a lower charge transfer resistance at the electrode-electrolyte interface. This typically indicates better ionic conductivity, suggesting that the electrode's modified structure, made possible by the dissolvable LiClO₄ template, facilitates easier and faster movement of ions between the anode and the electrolyte. This enhancement may be crucial for improving the overall electrochemical performance of the battery, particularly in terms of faster charging and discharging rates.

The subject matter of this disclosure encompasses the following aspects:

A first aspect relates to a method of fabricating a porous anode for a lithium-ion battery, the method comprising: forming an anode coating on a conductive substrate, the anode coating comprising an anode material, a solvent, a dissolved lithium salt and a binder; crystallizing the dissolved lithium salt to form lithium salt crystals throughout the anode coating; removing the solvent from the anode coating, leaving the anode material with the lithium salt crystals distributed therein adhered to the conductive substrate; after removing the solvent, compacting the anode material containing the lithium salt crystals on the conductive substrate, thereby forming an anode; and immersing the anode in an electrolyte, whereby the electrolyte penetrates the anode material and the lithium salt crystals dissolve into the electrolyte, leaving pores in the anode material and increasing an ion concentration of the electrolyte.

A second aspect relates to the method of the preceding aspect, wherein forming the anode coating on the conductive substrate comprises coating a slurry onto the conductive substrate, wherein the slurry comprises the anode material, the solvent, the dissolved lithium salt and the binder.

A third aspect relates to the method of the second aspect, wherein coating the slurry onto the conductive substrate comprises a slurry coating method selected from the group consisting of doctor blade coating, spin coating, dip coating, spray coating and bar coating.

A fourth aspect relates to the method of any preceding aspect, wherein the solvent is removed during or after crystallization of the dissolved lithium salt.

A fifth aspect relates to the method of any preceding aspect, wherein crystallization of the dissolved lithium salt is induced by cooling the anode coating to a temperature at or below a freezing point of the solvent.

A sixth aspect relates to the method of any preceding aspect, wherein, after crystallization, the solvent is removed from the anode coating by sublimation or freeze drying.

A seventh aspect relates to the method of the preceding aspect, wherein removal of the solvent occurs in a freeze dryer.

An eighth aspect relates to the method of any preceding aspect, wherein the sublimation or freeze drying is followed by vacuum drying of the anode material at a temperature above the freezing point of the solvent, whereby any remaining liquid solvent is evaporated.

A ninth aspect relates to the method of any preceding aspect, wherein crystallization of the dissolved lithium salt is induced by controlled drying of the anode coating.

A tenth aspect relates to the method of the preceding aspect, wherein, during the controlled drying, the solvent is removed from the anode coating by evaporation.

An eleventh aspect relates to the method of any preceding aspect, wherein the controlled drying of the anode coating takes place in an oven at a temperature of at least 70° C.

A twelfth aspect relates to the method of any preceding aspect, wherein the compacting comprises calendaring.

A thirteenth aspect relates to the method of any preceding aspect, wherein the anode coating further comprises a nucleation agent.

A fourteenth aspect relates to the method of the preceding aspect, wherein the nucleation agent comprises poly-l-lysine (PLL), polyethyleneimine (PEI), poly-L-glutamic acid, and/or polystyrene sulfonate (PSS).

A fifteenth aspect relates to the method of any preceding aspect, wherein the solvent comprises water.

A sixteenth aspect relates to the method of any preceding aspect, wherein the solvent comprises an organic liquid.

A seventeenth aspect relates to the method of any preceding aspect, wherein the solvent comprises ethylene carbonate (EC), dimethyl carbonate (DMC), dimethoxyethane (DME), dioxolane (DOL), and/or tetraethylene glycol dimethyl ether (TEGDME).

An eighteenth aspect relates to the method of any preceding aspect, wherein the anode material comprises graphite, lithium titanate (Li₄Ti₅O₁₂), silicon (Si), silicon (Si)-graphite composite, tin oxide (SnO₂), silicon oxide (SiO₂), and/or silicon suboxide (SiOₓ, where 0<x<2).

A nineteenth aspect relates to the method of any preceding aspect, wherein the lithium salt is selected from the group consisting of: lithium perchlorate (LiClO₄), lithium hexafluoroarsenate (LiAsF₆), lithium hexafluorophosphate (LiPF₆), lithium tetrafluoroborate (LiBF₄), lithium triflouromethanesulfonate or LiOTf (LiCF₃SO₃), lithium bis(trifluoromethanesulfonyl)imide (LiTFSI), lithium bis(pentafluoroethanesulfonyl)imide (LiBETI), lithium bis(oxalato)borate (LiBOB), lithium dicyanotriazolate (LiDCTA), lithium 4,5-dicyano-2-trifluoromethylimidazole (LiTDI), and lithium 4,5-dicyano-2-(pentafluoroethyl) imidazolide (LiPDI).

A twentieth aspect relates to the method of any preceding aspect, wherein, after a sufficient immersion time, the anode material is substantially devoid of the lithium salt crystals.

A twenty-first aspect relates to the method of any preceding aspect, wherein the immersion takes place in a battery cell, and wherein a cathode and a separator are also immersed in the electrolyte.

A twenty-second aspect relates to a method of assembling a lithium-ion battery cell, the method comprising: immersing a cathode, a separator, and an anode in an electrolyte, the anode comprising an anode material on a conductive substrate, the anode material including lithium salt crystals dispersed therein, wherein, upon immersing the anode in the electrolyte, the electrolyte penetrates the anode material and the lithium salt crystals dissolve into the electrolyte, leaving pores in the anode material and increasing an ion concentration of the electrolyte.

A twenty-third aspect relates to the method of the preceding aspect, wherein, after a sufficient immersion time, the anode material is substantially devoid of the lithium salt crystals.

A twenty-fourth aspect relates to the method of any preceding aspect, wherein the pores have a linear size in a range from about 1 micron to about 20 microns.

A twenty-fifth aspect relates to the method of any preceding aspect, wherein some or all of the pores have a length-to-width aspect ratio of greater than 1.

A twenty-sixth aspect relates to the method of any preceding aspect, wherein some or all of the pores have a long axis oriented substantially perpendicular to the conductive substrate.

A twenty-seventh aspect relates to a slurry for fabricating a porous anode for a lithium-ion battery, the slurry comprising: an anode material; a binder; a lithium salt; and a solvent for the lithium salt.

A twenty-eighth aspect relates to the slurry of the preceding aspect, wherein the anode material is selected from the group consisting of graphite, lithium titanate (Li₄Ti₅O₁₂), silicon (Si), silicon (Si)-graphite composite, tin oxide (SnO₂), silicon oxide (SiO₂), and/or silicon suboxide (SiOₓ, where 0<x<2).

A twenty-ninth aspect relates to the slurry of any preceding aspect, wherein the lithium salt is soluble in water.

A thirtieth aspect relates to the slurry of any preceding aspect, wherein the lithium salt becomes hydrated upon crystallization.

A thirty-first aspect relates to the slurry of any preceding aspect, wherein the lithium salt is selected from the group consisting of lithium perchlorate (LiClO₄), lithium hexafluoroarsenate (LiAsF₆), lithium hexafluorophosphate (LiPF₆), lithium tetrafluoroborate (LiBF₄), lithium triflouromethanesulfonate or LiOTf (LiCF₃SO₃), lithium bis(trifluoromethanesulfonyl)imide (LiTFSI), lithium bis(pentafluoroethanesulfonyl)imide (LiBETI), lithium bis(oxalato)borate (LiBOB), lithium dicyanotriazolate (LiDCTA), lithium 4,5-dicyano-2-trifluoromethylimidazole (LiTDI), and lithium 4,5-dicyano-2-(pentafluoroethyl) imidazolide (LiPDI).

A thirty-second aspect relates to the slurry of any preceding aspect, wherein the solvent comprises water.

A thirty-third aspect relates to the slurry of any preceding aspect, wherein the solvent comprises an organic solvent.

A thirty-fourth aspect relates to the slurry of any preceding aspect, wherein the organic solvent comprises ethylene carbonate (EC), dimethyl carbonate (DMC), dimethoxyethane (DME), dioxolane (DOL), and/or tetraethylene glycol dimethyl ether (TEGDME).

A thirty-fifth aspect relates to the slurry of any preceding aspect, wherein the binder comprises carboxylmethyl cellulose and/or styrene-butadiene rubber.

A thirty-sixth aspect relates to the slurry of any preceding aspect, further comprising a nucleation agent.

A thirty-seventh aspect relates to the slurry of the preceding aspect, wherein the nucleation agent comprises poly-l-lysine (PLL), polyethyleneimine (PEI), poly-L-glutamic acid, and/or polystyrene sulfonate (PSS).

A thirty-eighth aspect relates to the slurry of any preceding aspect, further comprising one or more conductive additives selected from the group consisting of carbon particles, carbon black, carbon nanotubes, and graphene.

A thirty-ninth aspect relates to a porous anode for a lithium-ion battery, the porous anode comprising: a conductive substrate; and an anode material on the conductive substrate, the anode material comprising a population of pores formed by removal of lithium salt crystals.

A fortieth aspect relates to the porous anode of the preceding aspect, wherein the anode material is selected from the group consisting of graphite, lithium titanate (Li₄Ti₅O₁₂), lithium titanate (Li₄Ti₅O₁₂), silicon (Si), silicon (Si)-graphite composite, tin oxide (SnO₂), silicon oxide (SiO₂), and/or silicon suboxide (SiOₓ, where 0<x<2).

A forty-first aspect relates to the porous anode of any preceding aspect, wherein the pores have a linear size in a range from about 1 micron to about 20 microns.

A forty-second aspect relates to the porous anode of any preceding aspect, wherein some or all of the pores have a length-to-width aspect ratio of greater than 1.

A forty-third aspect relates to the porous anode of any preceding aspect, wherein some or all of the pores have a long axis oriented substantially perpendicular to the conductive substrate.

A forty-fourth aspect relates to the porous anode of any preceding aspect, wherein the conductive substrate comprises copper, aluminum, nickel and/or titanium.

A forty-fifth aspect relates to a battery cell including the porous anode of any preceding aspect.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

While various embodiments have been described, it will be apparent to those of ordinary skill in the art that many more embodiments and implementations are possible. Accordingly, the embodiments described herein are examples, not the only possible embodiments and implementations.

1. A method of fabricating a porous anode for a lithium-ion battery, the method comprising:
forming an anode coating on a conductive substrate, the anode coating comprising an anode material, a solvent, a dissolved lithium salt and a binder;
crystallizing the dissolved lithium salt to form lithium salt crystals throughout the anode coating;
removing the solvent from the anode coating, leaving the anode material with the lithium salt crystals distributed therein adhered to the conductive substrate;
after removing the solvent, compacting the anode material containing the lithium salt crystals on the conductive substrate, thereby forming an anode; and
immersing the anode in an electrolyte, whereby the electrolyte penetrates the anode material and the lithium salt crystals dissolve into the electrolyte, leaving pores in the anode material and increasing an ion concentration of the electrolyte.

2. The method of claim 1, wherein the solvent is removed during or after crystallization of the dissolved lithium salt.

3. The method of claim 1, wherein crystallization of the dissolved lithium salt is induced by cooling the anode coating to a temperature at or below a freezing point of the solvent.

4. The method of claim 1, wherein, after crystallization, the solvent is removed from the anode coating by sublimation or freeze drying.

5. The method of claim 4, wherein removal of the solvent occurs in a freeze dryer.

6. The method of claim 4, wherein the sublimation or freeze drying is followed by vacuum drying of the anode material at a temperature above the freezing point of the solvent, whereby any remaining liquid solvent is evaporated.

7. The method of claim 1, wherein crystallization of the dissolved lithium salt is induced by controlled drying of the anode coating, and
wherein, during the controlled drying, the solvent is removed from the anode coating by evaporation.

8. The method of claim 1, wherein the compacting comprises calendaring.

9. The method of claim 1, wherein the anode coating further comprises a nucleation agent selected from the group consisting of poly-l-lysine (PLL), polyethyleneimine (PEI), poly-L-glutamic acid, and polystyrene sulfonate (PSS).

10. The method of claim 1, wherein the anode material comprises graphite, lithium titanate (Li₄Ti₅O₁₂), silicon (Si), silicon (Si)-graphite composite, tin oxide (SnO₂), silicon oxide (SiO₂), and/or silicon suboxide (SiOₓ, where 0<x<2).

11. The method of claim 1, wherein the lithium salt is selected from the group consisting of: lithium perchlorate (LiClO₄), lithium hexafluoroarsenate (LiAsF₆), lithium hexafluorophosphate (LiPF₆), lithium tetrafluoroborate (LiBF₄), lithium triflouromethanesulfonate or LiOTf (LiCF₃SO₃), lithium bis(trifluoromethanesulfonyl)imide (LiTFSI), lithium bis(pentafluoroethanesulfonyl)imide (LiBETI), lithium bis(oxalato)borate (LiBOB), lithium dicyanotriazolate (LiDCTA), lithium 4,5-dicyano-2-trifluoromethylimidazole (LiTDI), and lithium 4,5-dicyano-2-(pentafluoroethyl) imidazolide (LiPDI).

12. The method of claim 1, wherein, after a sufficient immersion time, the anode material is substantially devoid of the lithium salt crystals.

13. The method of claim 1, wherein the immersion takes place in a battery cell, and
wherein a cathode and a separator are also immersed in the electrolyte.

14. A method of assembling a lithium-ion battery cell, the method comprising:
immersing a cathode, a separator, and an anode in an electrolyte, the anode comprising an anode material on a conductive substrate, the anode material including lithium salt crystals dispersed therein,
wherein, upon immersing the anode in the electrolyte, the electrolyte penetrates the anode material and the lithium salt crystals dissolve into the electrolyte, leaving pores in the anode material and increasing an ion concentration of the electrolyte.

15. A porous anode for a lithium-ion battery, the porous anode comprising:
a conductive substrate; and
an anode material on the conductive substrate, the anode material comprising a population of pores formed by removal of lithium salt crystals.

16. The porous anode of claim 15, wherein the anode material is selected from the group consisting of graphite, lithium titanate (Li₄Ti₅O₁₂), lithium titanate (Li₄Ti₅O₁₂), silicon (Si), silicon (Si)-graphite composite, tin oxide (SnO₂), silicon oxide (SiO₂), and/or silicon suboxide (SiOₓ, where 0<x<2).

17. The porous anode of claim 15, wherein the pores have a linear size in a range from about 1 micron to about 20 microns.

18. The porous anode of claim 15, wherein some or all of the pores have a length-to-width aspect ratio of greater than 1.

19. The porous anode of claim 15, wherein some or all of the pores have a long axis oriented substantially perpendicular to the conductive substrate.

20. A battery cell including the porous anode of claim 15.
